(19) United States
(12) Patent Application Publication
(10) Pub. No.: US 2009/0213010 A1
(43) Pub. Date: Aug. 27, 2009

(54) POLARIZED ANTENNA WITH REDUCED SIZE

(76) Inventor: Chih-Shen Chou, Miaoli County (TW)

Correspondence Address: NORTH AMERICA INTELLECTUAL PROPERTY CORPORATION, P.O. BOX 506, MERRIFIELD, VA, 22116, US

(21) Appl. No.: 12/129,700

(22) Filed: May 30, 2008

(30) Foreign Application Priority Data
Feb. 27, 2008 (TW) 097106792

(51) Int. Cl. H01Q 1/38

(52) U.S. Cl. 343/700 MS

(57) ABSTRACT

A polarized antenna with reduced size includes a substrate, a ground electrode, a radiation electrode and a side-feeding electrode. The substrate is made of dielectric materials, and the ground electrode, the radiation electrode and the side-feeding electrode are made of electrically conductive materials. By forming a plurality of characteristics-setting elements within the radiation electrode, the polarized antenna can have the advantages of wider bandwidth and smaller size. By changing the design of characteristics-setting elements, the circular polarization characteristics of the antenna can be adjusted or a linear polarization antenna can be obtained. The present invention can be implemented to become a through-hole device or an SMD device.

### BACKGROUND OF THE INVENTION

1. Field of the Invention

The present invention relates to a side-feeding polarized antenna, and more particularly, to an antenna design benefiting from a plurality of characteristic-setting elements formed within a radiation electrode of the antenna that make the antenna wider bandwidth and reduced size.

2. Description of the Prior Art

Compared with the other kinds of antennas, a microstrip antenna is smaller, lighter, thinner, and has a lower production cost. Therefore, it has been widely implemented in the military and space industry, and for satellite and commercial purposes. FIG. 1 shows a diagram of a conventional through-hole microstrip patch antenna. As shown in FIG. 1, the microstrip antenna 100 has a substrate 110 used as a body, a ground electrode 120 formed on the bottom surface of the substrate 110, and a radiation electrode 130 formed on the opposite side to the ground electrode 120. The substrate 110 is made of dielectric materials, and the ground electrode 120 and the radiation electrode 130 are made of electrically conductive materials. A through hole is formed around the center area of the substrate 110, and a metal stick 140 is set in the through hole to connect the radiation electrode 130 and an external signal processing device (not shown). This technique only applies to manufactured through-hole devices. The production cost is high. The resonant frequency cannot be pulled down easily.

FIG. 2 shows a diagram of a conventional surface-mount-device (SMD) microstrip patch antenna. The microstrip antenna 200 has a substrate 210 as a body, a ground electrode 220 formed on the bottom surface of the substrate 210, and a radiation electrode 230 formed on the opposite side to the ground electrode 220. One side surface 290 of the microstrip antenna 200 has a feeding electrode 250 that is utilized to replace the metal stick 140 shown in FIG. 1 to connect the external signal processing device and make the antenna become a surface mount device. FIG. 3 shows a structure of a circular polarization microstrip antenna disclosed in U.S. Pat. No. 6,140,968. In this structure, in order to adjust the circular polarization characteristics of the microstrip antenna 200, a second ground electrode 280 needs to be installed on the side surface 290 that the feeding electrode 250 is formed on, or an electrode needs to be disposed on every side surface of the substrate 220. The manufacturing of the antenna 200 is complex and the production cost is high. Moreover, it is difficult to adjust the circular polarization characteristic of the antenna 200, and its bandwidth is narrow; its size not easy to be reduced.

### SUMMARY OF THE INVENTION

One objective of the present invention is therefore to provide a polarized antenna that can have a low resonant frequency along with a small size. This goal is accomplished by a plurality of characteristic-setting elements formed within the radiation electrode. The polarized antenna can either be an SMD or a through-hole device, depending on the system requirement. By providing the characteristic-setting elements, the polarization characteristic of the antenna can be easily adjusted while having larger bandwidth.

According to one exemplary embodiment of the present invention, a polarized antenna is disclosed. The polarized antenna comprises a substrate, wherein a ground electrode is disposed on a first surface of the substrate, and a radiation electrode and a feeding end of a side-feeding electrode are disposed on a second surface of the substrate. The substrate is made of dielectric materials, and the ground electrode, the radiation electrode and the side-feeding electrode are made of electrically conductive materials. Within the radiation electrode, a plurality of characteristic-setting elements, such as two symmetrical arc areas, is formed. The characteristic-setting elements can be areas in the radiation electrode that have no electrically conductive materials, or areas in the radiation electrode where the electrically conductive materials have been removed, or areas in the radiation electrode that are formed with non-conductive materials. By modifying the design of the characteristic-setting elements, the polarization characteristic (such as the circular polarization characteristics, elliptical polarization characteristics, or linear polarization characteristics) and the resonant frequency of the polarized antenna can be adjusted to comply with the requirements in implementation.

Moreover, the feeding electrode of the polarized antenna is disposed outside the radiation electrode. The polarized antenna can therefore become an SMD device with the disposition of a side microstrip line, or become a through-hole device by making a through hole that passes through the substrate and setting an electrically conductive metal pin in the through hole to connect the radiation electrode and a signal processing device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows a diagram of a conventional through-hole microstrip patch antenna.

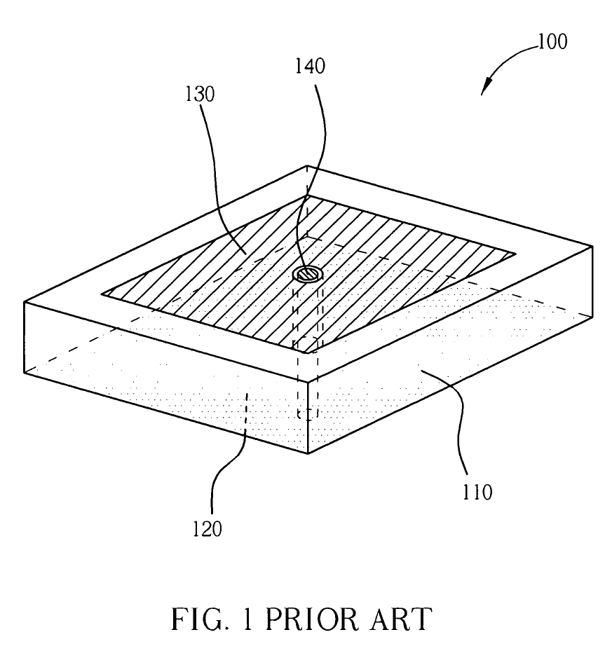

FIG. 2 shows a diagram of a conventional side-feeding microstrip antenna.

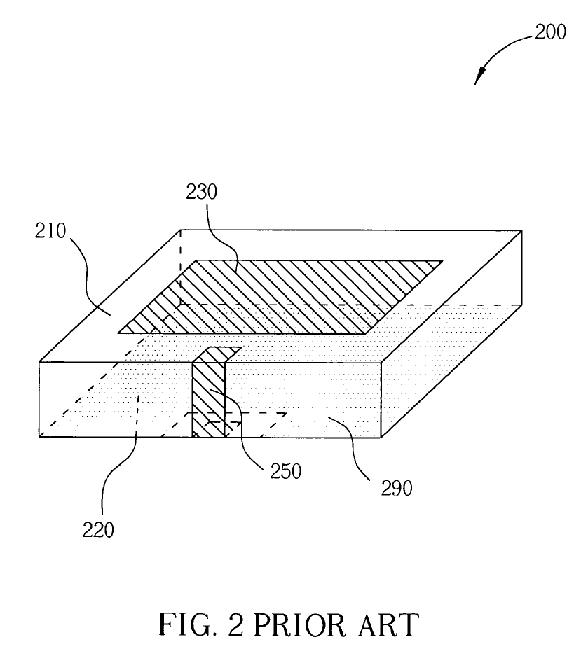

FIG. 3 shows a diagram of a conventional side-feeding circular polarization microstrip antenna.

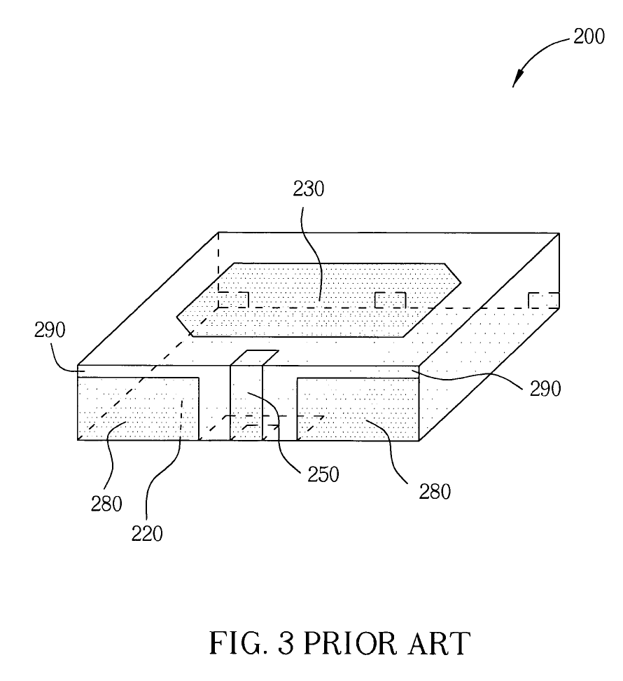

FIG. 4 shows a diagram of a microstrip antenna according to one exemplary embodiment of the present invention.

FIG. 5 shows a diagram of signal marching routes of the microstrip antenna in FIG. 4.

FIG. 6 shows a diagram of a microstrip antenna according to another exemplary embodiment of the present invention.

FIG. 7 shows a diagram of a microstrip antenna according to another exemplary embodiment of the present invention.

FIG. 8 shows a diagram of a microstrip antenna according to another exemplary embodiment of the present invention.

FIG. 9 shows a diagram of a microstrip antenna according to another exemplary embodiment of the present invention.

FIG. 10 shows a diagram of a through-hole-feeding microstrip antenna according to another exemplary embodiment of the present invention.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”.

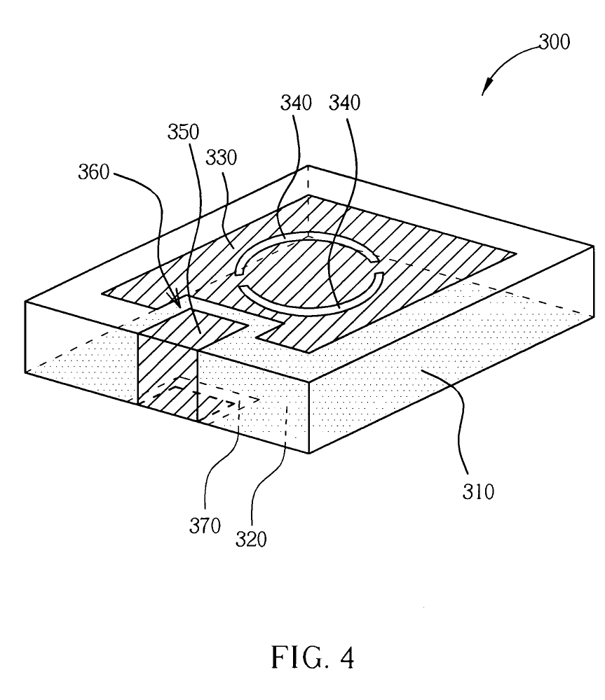

Please refer to FIG. 4, which shows a diagram of a polarized antenna according to one exemplary embodiment of the present invention. The polarized antenna 300 comprises a substrate 310 made of dielectric materials; for example, ceramics materials, magnetic materials, high polymer materials such as Teflon, or compound materials comprising the ceramics materials, magnetic materials or high polymer materials. The substrate 310 has a first surface and a second surface corresponding to the first surface. An electrically-conductive ground electrode 320 is formed on the first surface of the substrate 310, while an electrically-conductive radiation electrode 330 and an electrically-conductive side-feeding electrode 350 are formed on the second surface of the substrate 310. Within the radiation electrode 330, two symmetric arc characteristic-setting elements 340 are formed, wherein the characteristic-setting elements 340 can be gaps that have no electrically conductive materials in the radiation electrode 330 or bad electrically conductive areas in the radiation electrode 330. Please note that although the arc characteristic-setting elements 340 shown in FIG. 4 are in the shape of a half-ring, this is not a limitation of the present invention.

The side-feeding electrode 350 extends from the second surface to the first surface via a side surface of the substrate 310. An isolation area 370 having no electrically conductive layer is formed between the side-feeding electrode 350 and the ground electrode 320. A concave isolation area 360 having no electrically conductive layer is formed between the side-feeding electrode 350 and the radiation electrode 330.

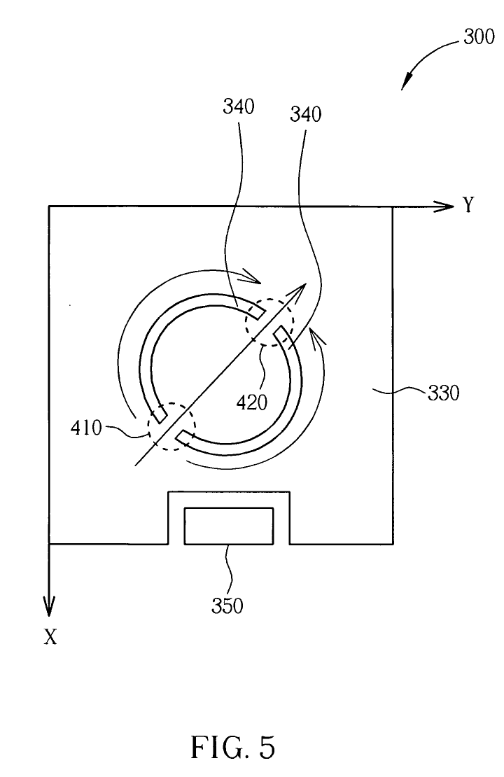

When a high-frequency signal couples from the side-feeding electrode 350 to the radiation electrode 330, the marching routes of the signal are shown in FIG. 5. Compared to the conventional polarized antenna designs, the signal marching routes of the polarized antenna 300 increase due to the characteristic-setting elements (the two arc characteristic-setting elements 340 in this embodiment) within the radiation electrode 330. Therefore the bandwidth at the resonance point of the polarized antenna 300 is widened, resulting in the increase of the receiving frequency range of the antenna 300.

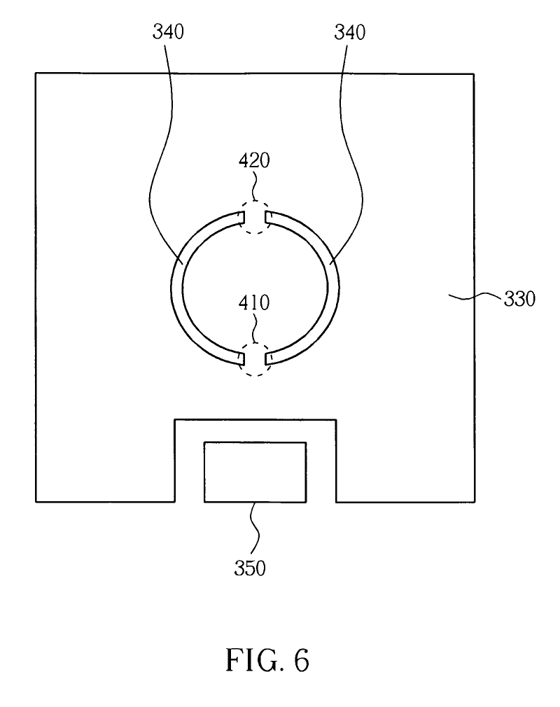

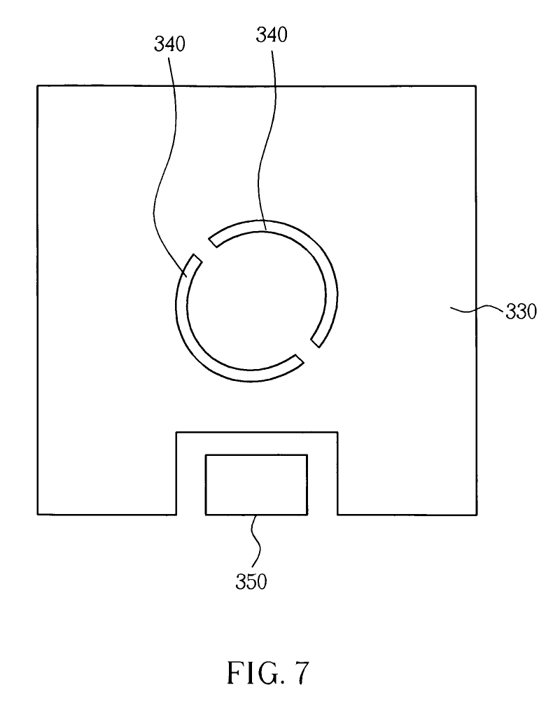

Furthermore, by properly modifying the length of the arc characteristic-setting elements 340 (for example, modifying the diameter of the half-ring in this embodiment) and modifying the locations where the passages 410 and 420 between the characteristic-setting elements 340 are set, a 90° phase difference can be generated between the X-axis electric field and Y-axis electric field, which makes the polarized antenna 300 have a circular polarization characteristic. If the location of the characteristic-setting elements 340 are modified so that the passages 410 and 420 are in a straight line with the side-feeding electrode 350, as shown in FIG. 6, the polarized antenna 300 becomes a linear polarized antenna. The relative direction of the passages 410, 420 and the side-feeding electrode 350 determines the direction of circular polarization: in the embodiment shown in FIG. 4 and FIG. 5, the polarized antenna 300 is provided with the right hand circular polarization (RHCP) characteristic; however, when the characteristic-setting elements 340 are disposed as shown in FIG. 7, the polarized antenna 300 is provided with the left hand circular polarization (LHCP) characteristic.

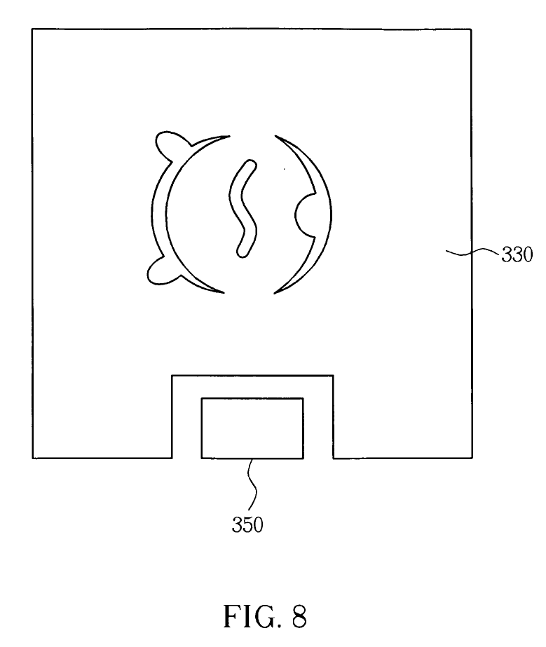

Please note that the arc characteristic-setting elements 340 are an embodiment rather than a limitation of the present invention. Other shapes that differ slightly from an arc can also achieve similar effects. For example, the characteristic-setting elements 340 can be a combination of an eyebrow shape, a semicircular shape, an ‘S’ shape or line segments, or a shape having some slight concave and convex features added to the above-mentioned shapes. These modifications all belong to the scope of the present invention. Moreover, ‘symmetry’ is not a necessary limitation of the present invention for achieving the above-mentioned functionalities. For example, the asymmetric patterns shown in FIG. 8 can also have substantially the same effects.

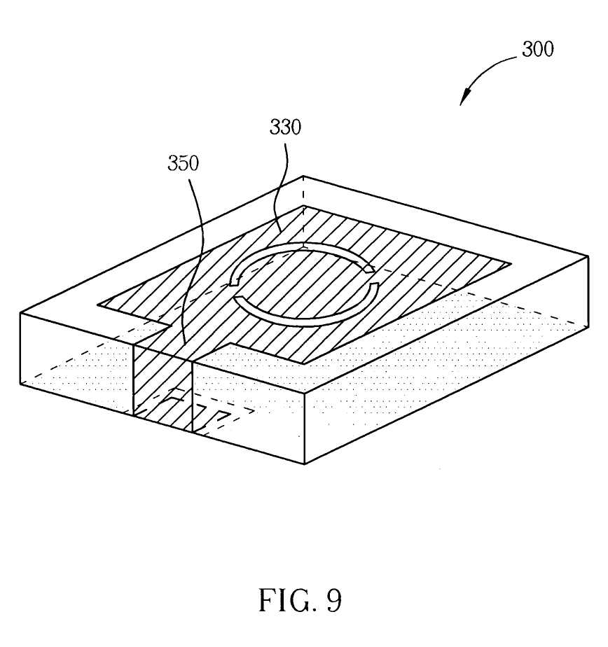

Please refer to FIG. 4 again. The side-feeding electrode 350 is disposed on the second surface (i.e. the surface that the radiation electrode 330 is formed on) of the substrate 310, and extends to the first surface (i.e. the surface that the ground electrode 320 is formed on) via the side surface of the substrate 310. In this embodiment, a nonconductive isolation area 370 is formed between the ground electrode 320 and the side-feeding electrode 350, and a nonconductive concave isolation area 360 is formed between the radiation electrode 330 and the side-feeding electrode 350. In another embodiment, as shown in FIG. 9, the side-feeding electrode 350 connects directly to the radiation electrode 330. These different structures can all enable the polarized antenna 300 to be used as a surface mount device.

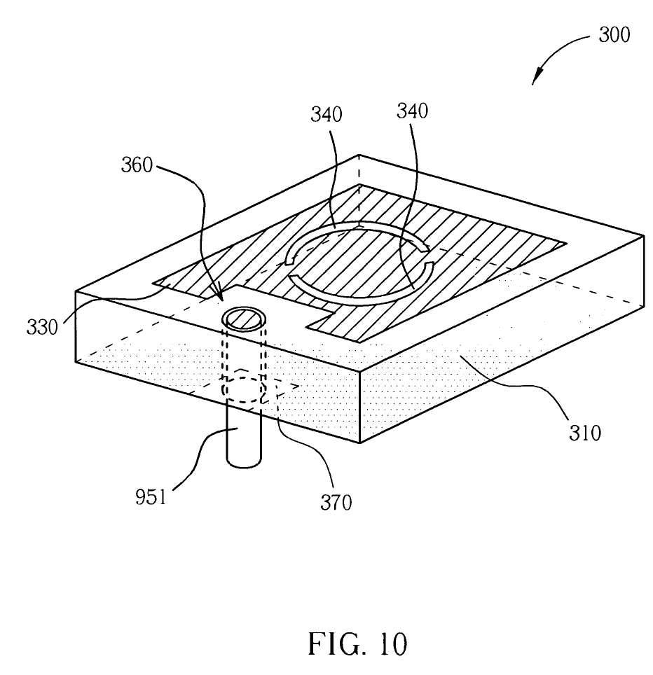

FIG. 10 shows another embodiment of the present invention. As shown in FIG. 10, at the location outside the radiation electrode 300 where the side-feeding electrode is originally disposed, a through hole passing through the substrate 310 is formed. A conductor 951 such as a metal stick is disposed inside the through hole, and is used as a feeding electrode to feed in signals. In this way, the polarized antenna 300 can still have the polarization characteristics disclosed in the above embodiments where the feeding electrode extends through the side surface of the substrate 310, but the polarized antenna 300 is suitable for conventional through-hole fabrication techniques. Please note that the above-mentioned modifications and designs are applicable to this embodiment; for example, the feeding electrode 951 can connect directly to the radiation electrode 330, or a nonconductive concave isolation area can be formed between the feeding electrode 951 and the radiation electrode 330. In another embodiment, the shape of the radiation electrode 330 corresponding to the feeding electrode 951 can be a concave or a line. The feeding electrode 951 can be located close to a side of the substrate 310, or on a corner of the substrate 310. A person having ordinary skill in the art can appreciate how to apply the above modifications to this embodiment, and therefore detailed description is omitted here for brevity. The polarized antenna 300 shown in FIG. 10 is suitable to be a through-hole device. Compared to the conventional microstrip antenna 100, the through hole and the feeding electrode 951 of the polarized antenna 300 are not located in the center area of the radiation electrode 330, thereby a low resonant frequency of the polarized antenna 300 and a reduced size can be achieved.

Please note that the above embodiments and the disclosed figures are for illustrative purposes only. The present invention does not limit the sizes and shapes of the substrate 310, the ground electrode 320, the radiation electrode 330, the characteristic-setting elements 340 and the feeding electrode 350 (951). For example, the substrate 310 can be rough and not flat, or have a multi-layer structure composed of a stack of radiation conductive layers and nonconductive layers. Furthermore, a nonconductive layer can be formed on the radiation electrode 330 to isolate air from oxidizing the radiation electrode 330 and to increase the dielectric coefficient and lower the resonant frequency. These designs that are derived from the spirit of the present invention all fall within the scope of the present invention.

Those skilled in the art will readily observe that numerous modifications and alterations of the device and method may be made while retaining the teachings of the invention.

What is claimed is:

1. A polarized antenna, comprising:
a substrate, comprising a first surface and a second surface;
a ground electrode, formed on the first surface of the substrate;
a radiation electrode, formed on the second surface of the substrate and having a plurality of characteristic-setting elements within; and
a feeding end of a side-feeding electrode, formed on the second surface of the substrate.

2. The polarized antenna of claim 1, wherein the characteristic-setting elements are gaps or bad conductive areas within the radiation electrode.

3. The polarized antenna of claim 2, wherein patterns of the characteristic-setting elements are two symmetric arcs.

4. The polarized antenna of claim 2, wherein patterns of the characteristic-setting elements comprise arcs or arc-like shapes.

5. The polarized antenna of claim 1, wherein an area surrounded by the characteristic-setting elements comprises a plurality of passages.

6. The polarized antenna of claim 5, wherein locations of the passages and locations of the feeding end of the side-feeding electrode correspond to polarization characteristic of the polarized antenna.

7. The polarized antenna of claim 6, wherein the passages and the feeding end are located in a line so as to make the polarized antenna have a linear polarization characteristic.

8. The polarized antenna of claim 6, wherein the passages and the feeding end are not located in a line so as to make the polarized antenna have a circular polarization characteristic.

9. The polarized antenna of claim 1, being a patch antenna.

10. The polarized antenna of claim 1, wherein the feeding end formed on the second surface of the substrate is for feeding a transmission signal to the radiation electrode.

11. The polarized antenna of claim 1, wherein the feeding end of the side-feeding electrode is located around a side or a corner of the substrate.

12. The polarized antenna of claim 1, wherein the substrate further comprises a third surface and the feeding end of the side-feeding electrode extends from the second surface to the third surface.

13. The polarized antenna of claim 12, being a surface-mount-device (SMD) patch antenna.

14. The polarized antenna of claim 1, wherein the side-feeding electrode is a conductor passing through the substrate from the second surface.

15. The polarized antenna of claim 14, being a through-hole-device patch antenna.

16. The polarized antenna of claim 1, wherein the substrate comprises dielectric materials, magnetic materials, or macromolecular materials.

17. The polarized antenna of claim 1, wherein the first surface or the second surface of the substrate is not flat.

18. The polarized antenna of claim 1, wherein the substrate has a multi-layer structure.
